(19) United States
(12) Patent Application Publication
(10) Pub. No.: US 2012/0299836 A1
(43) Pub. Date: Nov. 29, 2012

(54) DIGITIZER WITH SPREAD SPECTRUM CIRCUIT

(76) Inventor: Cheng-Liang HSIEH, Hsin-Chu (TW)

(21) Appl. No.: 13/113,410

(22) Filed: May 23, 2011

(51) Int. Cl. G06F 3/041

(52) U.S. Cl. 345/173; 178/18.03

(57) ABSTRACT

A digitizer with spread spectrum circuit is disclosed herein, and includes an emitting circuit, a processor, an antenna sensing board and a receiving circuit. The processor controls the spread spectrum circuit to determine the frequency bandwidth of the electromagnetic wave signal. The emitting circuit is electrically connected to the spread spectrum circuit and the spread spectrum circuit informs the emitting circuit the bandwidth of the electromagnetic wave signal to transmit. The antenna sensing board is electrically connected to the emitting circuit and configured to emit and receive the electromagnetic wave signal power. The receiving circuit is configured to receive an oscillating signal generated by an electromagnetic stylus and transmit the signal to the processor.

### FIELD OF THE INVENTION

The present invention is related to a digitizer, and more particularly, related to a digitizer with a spread spectrum circuit configured to allow the digitizer to receive maximum power.

### DESCRIPTION OF THE PRIOR ART

In the present digitizer technology, the passive electromagnetic touch technique is generally used in the current market. FIG. 1A is a view illustrating a conventional passive electromagnetic digitizer. As shown in FIG. 1A, the processor 102 in the conventional digitizer 10 controls the emitting circuit 104 to transmit an electromagnetic wave signal to the sensor board 106. The sensor board 106 will transmit a signal with fixed frequency to a stylus 106 and the fixed frequency is the baseband frequency. The oscillator in the stylus 106 is designed to include the same oscillation points same as the baseband frequencies. When the sensor board 106 transmits the electromagnetic wave signal to the stylus 108, the oscillator in the stylus 108 will generate a resonance frequency signal and the sensor board 106 will receive the maximum electromagnetic power of the resonance frequency signal.

The oscillator in the stylus 108 is a LC oscillator. In order to perform different pressure levels, the inductance (L) or the capacitance (C) is varied to change the frequency when the stylus 108 is pressed down. When the sensor board 106 receives the frequency different to the baseband, the pressure of the stylus 108 is recognized and the pressure level is determined.

When the stylus 108 is depressed, the resonance frequency of the stylus 108 would linear change. Therefore, the resonance point of the LC oscillator of the stylus 108 for the baseband frequency is shifted, as shown in FIG. 1B. When the sensor board 106 continues to transmit the baseband frequency, the power received by the stylus 108 is not the maximum power and some electromagnetic wave signal power would be lost. When the stylus 108 is depressed, the resonance wave signal power is not strong enough and the power received by the sensor board 106 is weak to cause the error of the touch detection. Therefore, if the power frequency transmitted from the sensor board 106 is a bandwidth instead of a frequency point, the resonance frequency of the stylus 108 is located within this bandwidth. When the stylus 108 is pressed down, no matter where the resonance frequency is shifted and the resonance frequency is always located within the power bandwidth. The stylus 108 is able to receive the maximum power.

### SUMMARY OF THE INVENTION

One object of the present invention is to provide a digitizer and the digitizer includes a spread spectrum circuit. The spread spectrum circuit is configured to control the digitizer to transmit a bandwidth of the electromagnetic wave signal.

Another object of the present invention is to provide a digitizer and the stylus can receive the maximum power according to the bandwidth of the electromagnetic wave signal transmitted by the digitizer when the resonance signal frequency of the digitizer is shifted.

According to objects described above, a digitizer with spread spectrum circuit is disclosed herein and includes a processor, a spread spectrum circuit, an emitting circuit, a sensor board and a receiving circuit. The processor controls the spread spectrum circuit to determine a bandwidth of an electromagnetic wave signal. The emitting circuit is electrically connected to the spread spectrum circuit, and the spread spectrum circuit indicates the bandwidth of the electromagnetic wave signal transmitted by the emitting circuit. The sensor board is electrically connected to the emitting circuit and configured to receive the electromagnetic wave signal and transmit the electromagnetic wave signal for a stylus to receive. The receiving circuit is electrically connected to the sensor board and the processor, and configured to receive a resonance signal generated by the stylus and transmit the resonance signal to the processor.

According to objects described above, a digitizer with spread spectrum circuit disclosed herein and includes a processor, a spread spectrum circuit, an emitting circuit, a sensor board and a receiving circuit. The processor controls the spread spectrum circuit to determine a bandwidth of an electromagnetic wave signal. The emitting circuit is electrically connected to the spread spectrum circuit, and the spread spectrum circuit indicates the bandwidth of the electromagnetic wave signal transmitted by the emitting circuit. The sensor board is electrically connected to the emitting circuit and configured to receive the electromagnetic wave signal and transmit the electromagnetic wave signal for a stylus to receive. The receiving circuit is electrically connected to the sensor board and the processor and configured to receive a resonance signal generated by the stylus and transmit the resonance signal to the processor. Wherein the spread spectrum circuit adjusts the bandwidth of the electromagnetic if frequency the resonance signal is not within the bandwidth of the electromagnetic wave signal, and the emitting circuit transmits another one of the bandwidth of the electromagnetic wave signal.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A is a view illustrating a conventional digitizer;

FIG. 1B is a signal view illustrating a conventional digitizer;

FIG. 2A is a view illustrating a digitizer with spread spectrum circuit in the present invention; and

FIG. 2B is a signal view illustrating the digitizer in the present invention.

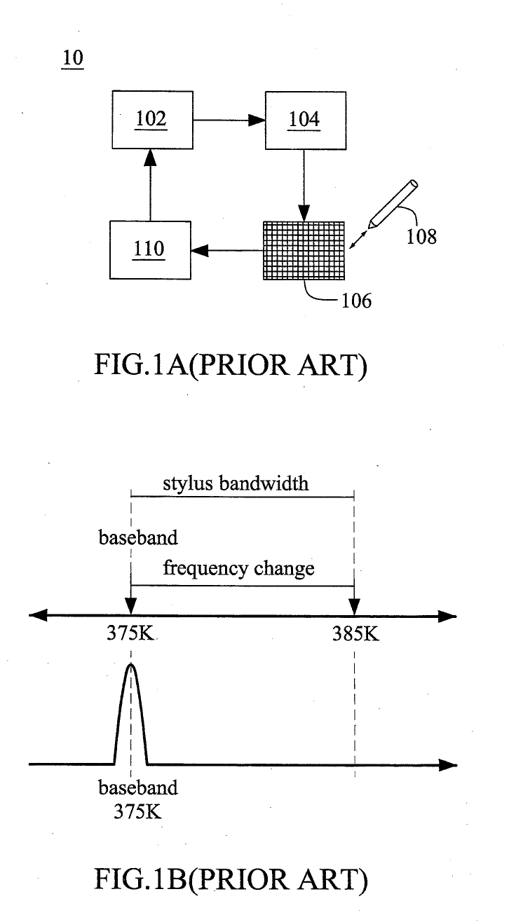

### DESCRIPTION OF THE PREFERRED EMBODIMENT

The following detailed description of the present invention describes a video call method and system thereof necessary to provide an understanding of the present invention, but does not cover a complete structure composition and the operating theory. The portions relating to the conventional techniques are briefly described, and the parts of the drawings are not proportionally drafted. While embodiments are discussed, it is not intended to limit the scope of the present invention. Except expressly restricting the amount of the components, it is appreciated that the quantity of the disclosed components may be greater than that disclosed.

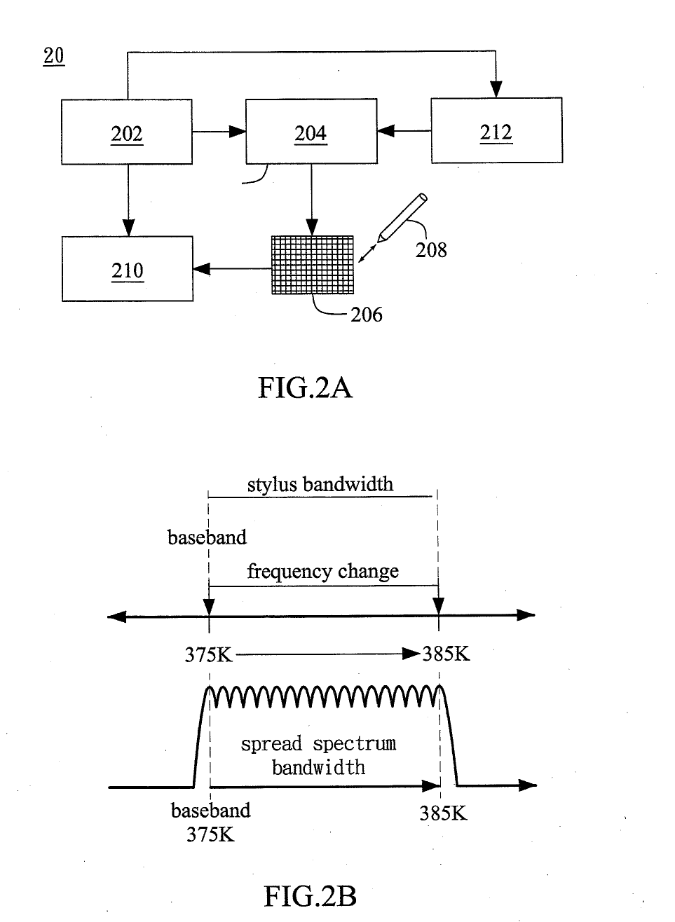

FIG. 2A is a view illustrating a digitizer in the present invention. As shown in FIG. 2A, the digitizer 20 in the present embodiment includes a processor 202, an emitting circuit 204, a sensor board 206, a stylus 208, a receiving circuit 210 and a spread spectrum circuit 212. The emitting circuit 204 is electrically connected to the processor 202 and the sensor board 206. The processor 202 of the digitizer 20 is configured to control the emitting circuit to transmit or stop transmitting electromagnetic wave signal (baseband signal) with a fixed bandwidth. In the meantime, the sensor board 206 will transmit the electromagnetic wave signal with fixed bandwidth (ex 375-385 KHz) to the stylus 208. The LC oscillator (not shown) of the stylus 208 will generate the resonance signal. When the stylus 208 is pressed down (in writing status), the inductance (L) or the capacitance (C) is varied to change the resonance signal frequency. When the signal received by the receiving circuit 210 is different to the baseband, the signal is transmitted to the processor 202 to determine the pressure so as to generate a pressure level. The spread spectrum circuit 212 is electrically connected to the processor 202 and the emitting circuit 204.

However, still referring to FIG. 2A, comparing to the circuit design of the conventional digitizer, the processor 202 in the present invention will control the spread spectrum circuit 212 to determine the resonance bandwidth of the transmitting power, and then the processor 202 controls the emitting circuit 204 to transmit or stop transmitting the electromagnetic wave signal with fixed bandwidth to the sensor board 206. When the electromagnetic wave signal with fixed bandwidth is transmitted, the processor 202 controls the receiving circuit 210 to receive or stop receiving the power transmitted from the stylus 208. After receiving the power, the processor 202 is going to do the signal processing so as to output the coordinate data and the pressure level (touch determination information). Before the next signal is transmitted and received, the processor 202 in the present invention would compare the current received signal with the previous received signal to determine whether the stylus 208 is pressed down or not. When the stylus 208 is pressed down, the processor 202 compares the electromagnetic wave signal bandwidth with the resonance frequency signal. If the resonance frequency is not within the electromagnetic wave signal bandwidth or the resonance frequency is weak, the spread spectrum circuit 212 will adjust the bandwidth of the electromagnetic wave signal transmitted by the emitting circuit 204 and the emitting circuit 204 is able to transmit the electromagnetic wave signal and the resonance signal is within the bandwidth of the electromagnetic wave signal. Therefore, the stylus 208 is continuously received the maximum power so as to decrease the detection error.

FIG. 2B is a signal view of the digitizer in the present invention. As shown in FIG. 2B, for example, when the baseband frequency range is about 375 KHz-385 KHz, the resonance frequency of the stylus 208 is about 375 KHz. When the stylus 208 is pressed down, if the resonance frequency is shifted to 385 KHz, the resonance is effective because the resonance frequency is within the bandwidth of the baseband. If the resonance frequency is shifted beyond (more or less) the bandwidth of the baseband, the bandwidth is adjusted for the resonance frequency of the stylus 208 to locate within the bandwidth. The processor 202 in the present invention is able to control the spread spectrum circuit 212 to setup the frequency range of the power, for example, the bandwidth of the present embodiment is between 375-385 KHz. The spread spectrum circuit 212 will inform the emitting circuit 204 of the frequency range of the transmitting power and the processor 202 will control the emitting circuit 204 to transmit or stop transmitting the power bandwidth to the sensor board 206. When the power bandwidth is transmitted, the processor 202 controls the receiving circuit 210 for the sensor board 206 to receive or stop receiving the response power from the stylus 208. After receiving, the processor 202 will do the signal processing to determine the coordinate and the pressure level.

Therefore, when the stylus 208 is pressed down, because of the spread spectrum circuit 212, the weak of the electromagnetic wave signal caused by the stylus 208 won't affect the overall efficiency of the digitizer 20 due to the shifted resonance frequency of the stylus 208. No matter where the resonance frequency of the stylus 208 is shifted, the resonance frequency is always located within the bandwidth of the electromagnetic wave signal transmitted by the sensor board 206 and the resonance is effective. The touch detection of the stylus 208 won't be wrong when the baseband signal received by the stylus 208 is error because of the shifted baseband signal. The spread spectrum circuit 206 can control the bandwidth transmitted by the emitting circuit 204. It should be noted that the bandwidth (375 KHz-385 KHz) described above is used to explain the frequency shifted problem of the stylus 208 and the bandwidth is not limited at this frequency range in the digitizer 20 of the present invention. As long as the frequency shifted (not within 375 KHz-385 KHz) caused by the stylus 208, the processor 202 will compare the resonance frequency signal with the electromagnetic wave bandwidth. If the signal is shifted, the processor 202 controls the spread spectrum circuit 212 to adjust the bandwidth in accordance with the shifted signal so as to control the emitting circuit 204 to transmit the electromagnetic wave signal power with new bandwidth. It should be noted that the bandwidth set by the spread spectrum circuit 212 includes all the different range of the baseband and the emitting circuit is able to transmit the bandwidth of the electromagnetic wave signal.

Although specific embodiments have been illustrated and described, it will be appreciated by those skilled in the art that various modifications may be made without departing from the scope of the present invention, which is intended to be limited solely by the appended claims.

What is claimed is:

1. A digitizer with spread spectrum circuit, comprising:
a processor;
a spread spectrum circuit and the processor controls the spread spectrum circuit to determine a bandwidth of an electromagnetic wave signal;
an emitting circuit electrically connected to the spread spectrum circuit, and the spread spectrum circuit indicates the bandwidth of the electromagnetic wave signal transmitted by the emitting circuit;
a sensor board electrically connected to the emitting circuit and configured to receive the electromagnetic wave signal and transmit the electromagnetic wave signal for a stylus to receive; and
a receiving circuit electrically connected to the sensor board and the processor and configured to receive a resonance signal generated by the stylus and transmit the resonance signal to the processor.

2. The digitizer of claim 1, wherein the processor compares the bandwidth of the electromagnetic wave signal and the resonance signal.

3. The digitizer of claim 2, wherein the spread spectrum circuit adjusts the bandwidth of the electromagnetic if frequency the resonance signal is not within the bandwidth of the electromagnetic wave signal, and the emitting circuit transmits another one of the bandwidth of the electromagnetic wave signal.

4. The digitizer of claim 3, wherein the stylus is able to receive maximum power of the electromagnetic wave signal so as to decrease determine error.

5. The digitizer of claim 1, wherein the digitizer is an electromagnetic digitizer.

6. The digitizer of claim 1, wherein the digitizer is a passive electromagnetic digitizer.

7. The digitizer of claim 1, wherein the processor controls the emitting circuit to transmit or stop transmitting the electromagnetic wave signal.

8. A digitizer with spread spectrum circuit, comprising:
a processor;
a spread spectrum circuit, and the processor controls the spread spectrum circuit to determine a bandwidth of an electromagnetic wave signal;
an emitting circuit electrically connected to the spread spectrum circuit, and the spread spectrum circuit indicates the bandwidth of the electromagnetic wave signal transmitted by the emitting circuit;
a sensor board electrically connected to the emitting circuit and configured to receive the electromagnetic wave signal and transmit the electromagnetic wave signal for a stylus to receive; and
a receiving circuit electrically connected to the sensor board and the processor and configured to receive a resonance signal generated by the stylus and transmit the resonance signal to the processor;
wherein the spread spectrum circuit adjusts the bandwidth of the electromagnetic if frequency the resonance signal is not within the bandwidth of the electromagnetic wave signal, and the emitting circuit transmits another one of the bandwidth of the electromagnetic wave signal.

9. The digitizer of claim 8, wherein the digitizer is an electromagnetic digitizer.

10. The digitizer of claim 8, wherein the digitizer is a passive electromagnetic digitizer.

11. The digitizer of claim 8, wherein the bandwidth is a baseband bandwidth.
